(19) United States
(12) Patent Application Publication
(10) Pub. No.: US 2026/0020533 A1
(43) Pub. Date: Jan. 22, 2026

(54) PLANT GERMINATION SYSTEMS AND METHODS

(71) Applicant: AETOS SYSTEMS INC., Huntsville, AL (US)

(72) Inventor: Thomas Walter Dreschel, Titusville, FL (US)

(21) Appl. No.: 18/780,349

(22) Filed: Jul. 22, 2024

Related U.S. Application Data
(60) Provisional application No. 63/673,282, filed on Jul. 19, 2024.

(51) Int. Cl. A01G 9/029

(52) U.S. Cl. CPC A01G 9/0293

(57) ABSTRACT

A system or germinating a plant in a soil medium includes a vessel defining a cavity, a germination paper, a seed coupled with the germination paper, and a layer positioned at least partially around the germination paper. An envelope may be positioned within the cavity and may define a receiving space. The germination paper and the layer are configured to be at least partially received by the receiving space of the envelope. A rooting medium may be positioned within the cavity of the vessel. The envelope may comprise a mesh material configured to prevent particles having a minimum diameter that is at least as great as a minimum diameter of the rooting medium from passing through the mesh material.

### CROSS-REFERENCE TO RELATED APPLICATION

This application claims priority to U.S. Provisional Patent Application No. 63/673,282 filed Jul. 19, 2024, the contents of which are hereby incorporated by reference in their entirety.

### STATEMENT REGARDING FEDERALLY SPONSORED RESEARCH OR DEVELOPMENT

This invention was made with Government support under 80KSC022CA010 awarded by the National Aeronautics and Space Administration. The Government has certain rights in the invention. In this context “government” refers to the government of the United States of America.

### FIELD OF THE DISCLOSURE

The present disclosure generally relates to a plant germination system, and more particularly to a plant germination system configured to maintain separation between a plant and a rooting medium.

### BACKGROUND OF THE DISCLOSURE

Harvesting root materials for testing typically involves having to clean the roots of the medium that the roots are grown in. However, in some instances, such as during spaceflight, roots are not able to be cleaned after extraction from the rooting medium because such harvests can release particles into the cabin environment. These particles, along with other foreign object debris (FOD) can cause many issues in the context of a space flight environment. For example, FOD can cause problems with electronics and astronaut health. Improved techniques for controlling, reducing and/or eliminating this debris when plants are harvested during sampling in space are generally desirable.

### SUMMARY OF THE DISCLOSURE

According to one aspect of the present disclosure, a method for germinating a plant in a soil medium may include steps of coupling a seed with the germination paper, coupling germination paper with a layer formed of a mesh material such that the layer extends at least partially around the germination paper, and placing the seed, the germination paper, and the layer within an envelope formed of the mesh material. The method may further include placing a support within the envelope adjacent to the seed, the germination paper, and the layer and placing the envelope with the seed, the germination paper, the layer, and the support within a vessel. A rooting medium may then be placed within the vessel, and the mesh material may be configured to prevent particles having an average diameter that is at least as great as the average diameter of the rooting medium from passing through the mesh material. The method may further include placing a foam insert and a collar on the vessel, wherein the foam insert defines at least one aperture configured to at least partially receive at least one of the envelope and the support. Once a plant has germinated from the seed, the plant, the germination paper, and the layer may be removed from the envelope.

According to another aspect of the present disclosure, a method for germinating a plant in a soil medium may include steps of coupling a seed with the germination paper, placing the seed and the germination paper within an envelope formed of a mesh material, and placing the envelope, the seed, and the germination paper within a vessel. A rooting medium may then be placed within the vessel, and the mesh material may be configured to prevent particles having an average diameter that is at least as great as the average diameter of the rooting medium from passing through the mesh material. Once a plant has germinated from the seed, the plant and the germination paper may be removed from the envelope.

According to another aspect of the present disclosure, a system for germinating a plant in a soil medium may include a vessel defining a cavity, a germination paper, a seed coupled with the germination paper, and a layer positioned at least partially around the germination paper. The seed may be positioned between the layer and the germination paper. An envelope may be positioned within the cavity and may define a receiving space. The germination paper and the layer are configured to be at least partially received by the receiving space of the envelope. A rooting medium may be positioned within the cavity of the vessel. The envelope may comprise a mesh material configured to prevent particles having an average diameter that is at least as great as the average diameter of the rooting medium from passing through the mesh material.

These and other aspects, objects, and features of the present disclosure will be understood and appreciated by those skilled in the art upon studying the following specification, claims, and appended drawings.

### BRIEF DESCRIPTION OF THE DRAWINGS

The following is a description of the figures in the accompanying drawings. The figures are not necessarily to scale, and certain features and certain view of the figures may be shown exaggerated in scale or in schematic in the interest of clarity and conciseness.

In the drawings:

FIG. 1 is a front elevation view of germination paper and a plurality of seeds, where some of the seeds are coupled with the germination paper, according to various examples.

FIG. 2 is a front elevation view of a wrap assembly, an envelope, a support, and a clip of a system for germinating plants, according to various examples.

FIG. 3 is a front elevation view of the components of FIG. 2 in which the wrap assembly is aligned with an opening of the envelope, according to various examples.

FIG. 4 is a side perspective view of the components of FIG. 2 with the wrap assembly partially inserted into the envelope, the support inserted into the envelope, and the clip separated from the envelope, the support, and the wrap assembly, according to various examples.

FIG. 5 is a side perspective view of the components of FIG. 2 with the wrap assembly and the support inserted into the envelope and the clip coupled with the envelope, according to various examples.

FIG. 6 is an exploded top perspective view of a chamber assembly of a system for germinating plants, according to various examples.

FIG. 7 is a top perspective view of a fixture within a vessel of a system for germinating plants, envelopes positioned within the vessel, and a wrap assembly and support positioned within each envelope, according to various examples.

FIG. 8 is a top perspective view of a foam insert and a cover for a system for germinating plants, according to various examples.

FIG. 9A is a top perspective view of the fixture, vessel, envelopes, wrap assemblies, and supports of FIG. 7 with a rooting medium partially filling a cavity of the vessel, according to various examples.

FIG. 9B is a top perspective view of the fixture, vessel, envelopes, wrap assemblies, and supports of FIG. 9A with the rooting medium filling the cavity of the vessel to a max fill line.

FIG. 10 is a top perspective view of the vessel, envelopes, wrap assemblies, and supports of FIG. 9B with the fixture removed from the vessel.

FIG. 11A is a top perspective view of the vessel, envelopes, wrap assemblies, and supports of FIG. 10 with a foam insert and a cover positioned on top of the rooting medium, according to various examples.

FIG. 11B is a top perspective view of the vessel, envelopes, wrap assemblies, foam insert, and cover of FIG. 11A with the supports removed.

FIG. 12 is a top perspective view of a system for germinating plants, according to various examples.

FIG. 13 is a top perspective view of the system of FIG. 12 with a lid removed and a germinated plant partially removed from the system, according to various examples.

FIG. 14 is a flow diagram of a method for germinating a plant in a soil medium, according to various examples.

### DETAILED DESCRIPTION

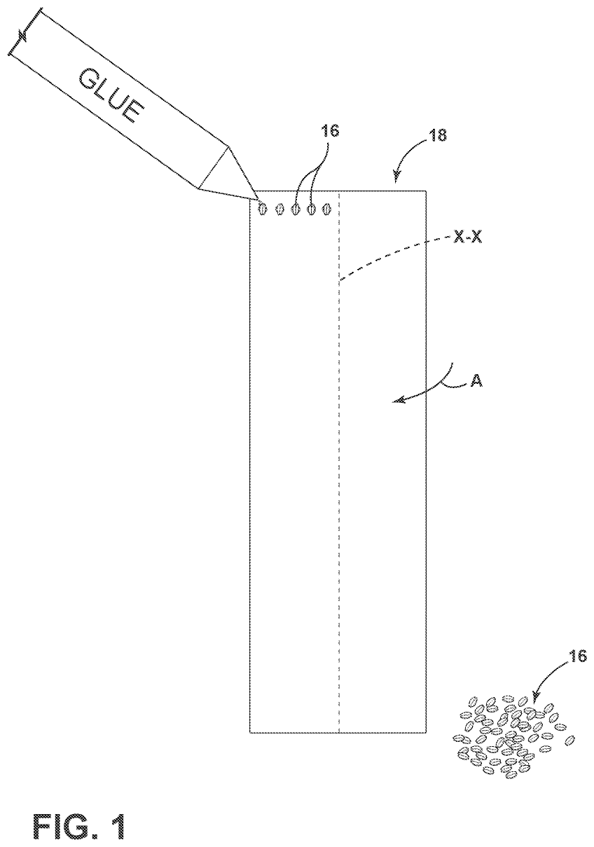

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As required, detailed examples of the present disclosure are disclosed herein. However, it is to be understood that the disclosed examples are merely exemplary of the disclosure that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present disclosure.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a system for germinating a plant in a rooting medium while maintaining separation of the plant from the rooting medium.

Referring generally to the figures, in some embodiments a plant germination system 10 may be configured for germinating a plant in a rooting medium and permitting removal of roots of the plant following germination without releasing rooting media to the environment. The system 10 may include a vessel 12 defining a cavity 14. A seed 16 may be coupled with a germination paper 18. A layer 20 may be positioned at least partially around the germination paper 18 such that the seed 16 may be positioned between the layer 20 and the germination paper 18. An envelope 22 may be positioned within the cavity 14 of the vessel 12 and may define an interior receiving space 24. The germination paper 18 and the layer 20 are configured to be at least partially received by the interior receiving space 24 of the envelope 22. A rooting medium 26 may be positioned within the cavity 14 of the vessel 12. The envelope 22 may comprise a mesh material configured to prevent particles having an average diameter that is at least as great as the average diameter of the rooting medium 26 from passing through the mesh material.

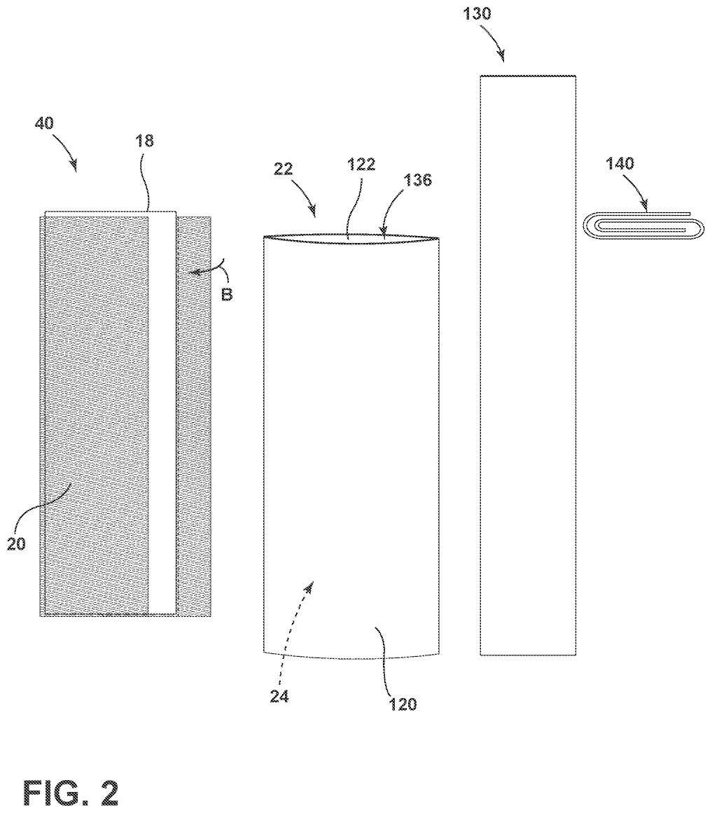

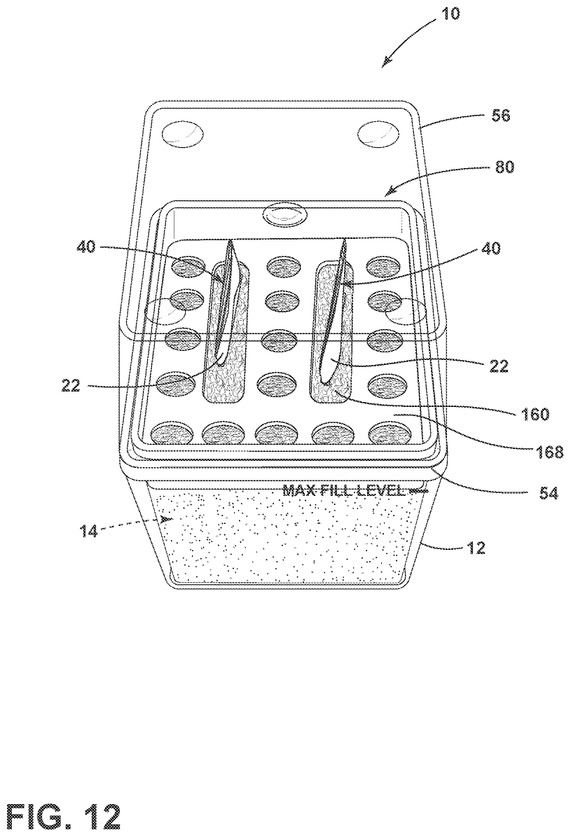

In some embodiments, a system 10 (FIG. 12) may include germination paper 18, which may form part of a wrap assembly 40 (see FIG. 2). The wrap assembly 40 may include a. The germination paper 18 is folded in half along line X-X lengthwise (see arrow A) to form a seed or root wrap. In various examples, the germination paper 18 may be about 6 centimeters wide and about 8.5 centimeters long. However, it is contemplated that other sizes of germination paper may be used without departing from the scope of the present disclosure.

Seeds 16 may be ungerminated plant seeds. In some embodiments, seeds 16 may comprise seeds of one or more species of plants. In some embodiments, at least one seed 16 may be an alfalfa plant species. In some embodiments, other species are possible.

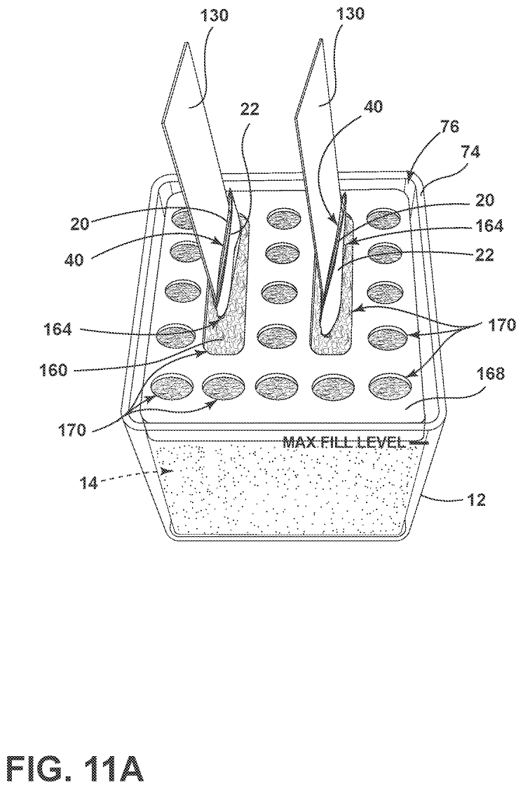

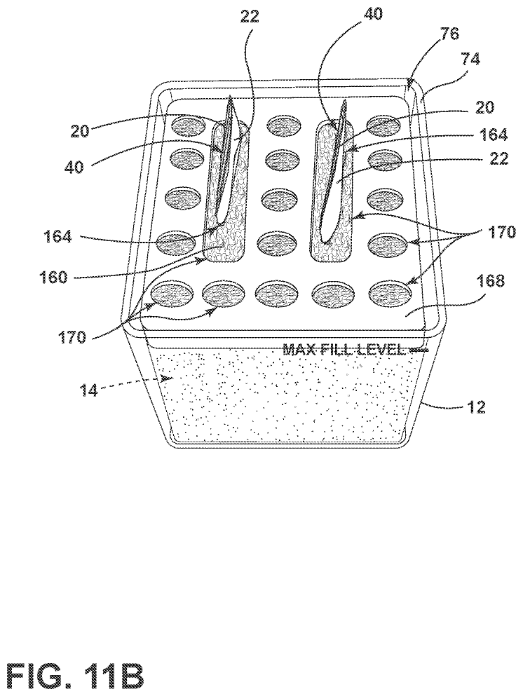

Seeds 16 are coupled with the germination paper 18 such that the seeds 16 are between the two halves of the germination paper 18 along an upper edge of the germination paper 18. The position of the seeds 16 on the germination paper 18 is selected to position the seeds 16 approximately at or above an uppermost surface of a foam insert 160 (see FIGS. 11A-11B) as discussed in more detail elsewhere herein. In various examples, the seeds 16 may be coupled with the germination paper 18 using an adhesive, such as, for example, glue. However, it is contemplated that other mechanisms for coupling the seeds 16 with the germination paper 18 may be used without departing from the scope of the present disclosure.

Referring now to FIG. 2, the wrap assembly 40 may further include a layer 20 configured to at least partially cover the germination paper 18. The layer 20 may be positioned at least partially around the germination paper 18. For example, the layer 20 may be wrapped around the germination paper 18 (see arrow B). In various examples, the layer 20 may be approximately the same size as the germination paper 18. For example, the layer 20 may be about 6 centimeters wide and about 8.5 centimeters long.

The layer 20 may be formed of a porous or mesh material. The layer 20 may comprise various substances capable of achieving the functionality ascribed herein to the layer 20. In some embodiments, the layer 20 may be formed of a screening material comprising one or more polymers, such as, for example, nylon (e.g., CAS #25035-04-5). In some embodiments, the material may be other nylon-based materials, such as a nylon monofilament fabric having properties the same as or similar to those of polyamide (CAS #63428-83-1), for example, Nitex®. In some embodiments, the material may be a nonbiodegradable material.

In some embodiments, the material of the layer 20 is configured to prevent particles having a predetermined average diameter from passing through. For example, the material of the layer 20 may be configured to prevent particles having an average diameter of about 2 millimeters from passing through. In other examples, the material of the layer 20 may be configured to prevent particles having an average diameter of about 1 millimeter, about 3 millimeters, about 4 millimeters, about 5 millimeters, or any value or range of values therebetween. In some embodiments, the material of the layer 20 may be configured to prevent particles having a minimum diameter from passing through. For example, the material of the layer 20 may be configured to prevent particles having a minimum diameter of about 1 millimeter, about 2 millimeters, about 3 millimeters, about 4 millimeters, about 5 millimeters, or any value or range of values therebetween. The material of the layer 20 is further configured to allow water and nutrients to pass through the material.

Referring again to FIG. 2, the system 10 (FIG. 12) further includes an envelope 22. In various examples, the envelope 22 may be generally shaped as a rectangular envelope. The envelope 22 may be about 5.5 cm wide by 10 centimeters long. However, it will be understood that the size and shape of the envelope 22 may be adjusted to accommodate various plant types, rooting mediums, and other germination considerations without departing from the scope of the present disclosure.

As shown in FIG. 2, the envelope 22 may have a first wall 120 and a second wall 122. The first and second walls 120, 122 may be coupled along opposing outer edges and along a joining edge extending between the opposing outer edges of the envelope 22. For example, the first and second walls 120, 122 may be coupled using sewing, staples, glue, adhesive, or any other mechanism that allows the first and second walls 120, 122 to be coupled about the opposing outer edges and the joining edge to form the envelope 22. It is further contemplated that the envelope 22 may be formed of a single piece of material folded to form a joining edge and then coupled along opposing outer edge without departing from the scope of the present disclosure.

The envelope 22 may comprise an internal receiving space 24 positioned between the first and second walls 120, 122. The interior receiving space 24 may be configured to at least partially receive the wrap assembly 40. In other words, the germination paper 18, the seed 16, and/or the layer 20 may be configured to be received by the interior receiving space 24 of the envelope 22. In other words, the interior receiving space 24 may be configured to at least partially receive any combination of the germination paper 18, the layer 20, and/or the seed(s) 16.

In various examples, the interior receiving space 24 may be further configured to receive one or more supports 130. The support 130 may be configured to at least partially support the wrap assembly 40 within the envelope 22 during insertion of the envelope 22 into a vessel 12. The support 130 may be formed of a rigid or semi-rigid material, such as, for example, plastic, polymeric material, or other material capable of supporting the wrap assembly 40. In various examples, the support 130 may be positioned at least partially within receiving space 24 of the envelope 22.

The envelope 22 may further comprise an opening 136 adjacent to and in communication with the interior receiving space 24. The opening 136 may be defined opposite the joining edge. The opening 136 is sized to receive the wrap assembly 40. In various examples, a clip 140 (e.g., spring clip, paperclip) or other mechanism for selectively pinching or closing the opening 136 may be configured to be selectively coupled with the envelope 22 proximate the opening 136 to close the opening 136. The clip 140 may be configured to close the opening 136 to prevent ingress of particles into the envelope (e.g., a rooting medium) as discussed in more detail elsewhere herein.

The envelope 22 may be formed of a porous or mesh material. For example, the envelope 22 may be formed of a screening material comprising one or more polymers, such as, for example, nylon (e.g., CAS #25035-04-5). In some embodiments, the material may be other nylon-based materials, such as a nylon monofilament fabric having properties the same as or similar to those of polyamide (CAS #63428-83-1), for example, Nitex®. In some embodiments, the material may be a nonbiodegradable material.

In some embodiments, the material of the envelope 22 is configured to prevent particles having a predetermined average diameter from passing through. For example, the material of the envelope 22 may be configured to prevent particles having an average diameter of about 2 millimeters from passing through. In other examples, the material of the envelope 22 may be configured to prevent particles having an average diameter of about 1 millimeter, about 3 millimeters, about 4 millimeters, about 5 millimeters, or any value or range of values therebetween. In some embodiments, the material of the envelope 22 may be configured to prevent particles having a minimum diameter from passing through. For example, the material of the envelope 22 may be configured to prevent particles having a minimum diameter of about 1 millimeter, about 2 millimeters, about 3 millimeters, about 4 millimeters, about 5 millimeters, or any value or range of values therebetween. The material of the envelope 22 is further configured to allow water and nutrients to pass through the material.

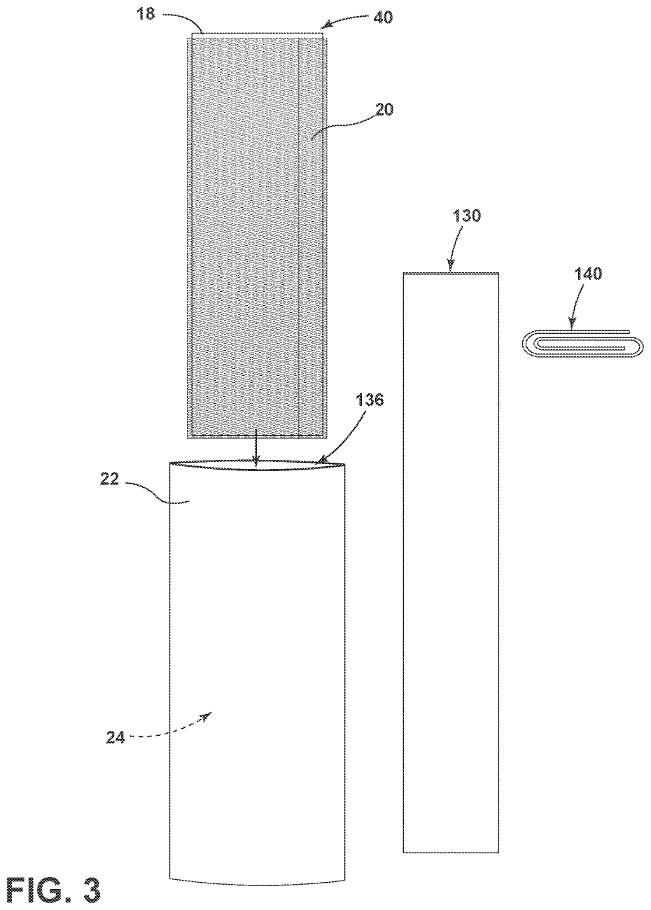

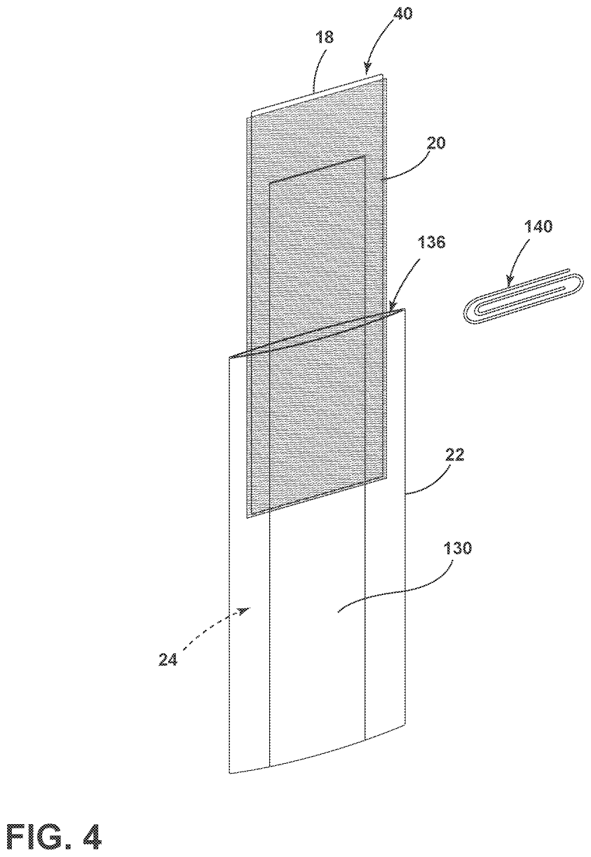

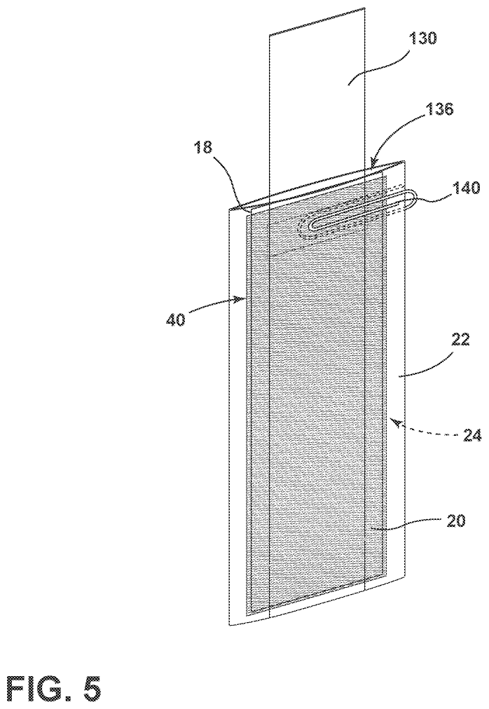

To illustrate preparation of the various components shown in FIG. 2 for use in plant germination as part of the system 10, FIGS. 3-5 depict various views of the preparation process. FIG. 3 is a front elevation view of the components of FIG. 2 in which the wrap assembly is aligned with an opening of the envelope. FIG. 4 is a side perspective view of the components of FIG. 2 with the wrap assembly partially inserted into the envelope, the support inserted into the envelope, and the clip separated from the envelope, the support, and the wrap assembly. FIG. 5 is a side perspective view of the components of FIG. 2 with the wrap assembly and the support inserted into the envelope and the clip coupled with the envelope.

In some embodiments the wrap assembly 40 may be positioned above the envelope 22 and inserted into the interior receiving space 24 via the opening 136. As shown in FIG. 4, the wrap assembly 40 may be inserted until a bottommost portion of the wrap assembly 40 contacts a scaled end of envelope 22 (e.g., the sealed joining end). In some embodiments, once the bottommost portion of the wrap assembly 40 is in contact with the sealed end of the envelope 22, a support 130 may be inserted into the interior receiving space 24 of the envelope 22 via the opening 136 between a surface of the wrap assembly 40 and an inner surface of a wall 120, 122 of envelope 22. In this regard, the support 130 may provide additional rigidity to the wrap assembly 40 when the wrap assembly 40 is positioned within an envelope 22, when the wrap assembly 40 is provided to vessel 12, and/or as the rooting media 26 is introduced to the vessel 12, as described further below. In some embodiments, a support 130 may be inserted into envelope 22 before the wrap assembly 40 is positioned within the interior receiving space 24 of the envelope 22. It will be understood that a user may decide an order by which each of the one or more of the wrap assembly 40 and the support 130 are inserted into the interior receiving space 24 of the envelope 22.

Once both of the wrap assembly 40 and the support 130 are inserted into the interior receiving space 24 of the envelope 22, a clip 140 may be applied to a surface of one or more of the envelope 22 and support 130, or even assembly 40. In this regard, the clip 140 may be configured to hold in place each of the support 130, the wrap assembly 40, and the envelope 22 relative to one another. In this way, the respective components 22, 40, 130 may remain in a desired position during insertion into vessel 12, and while rooting media 26 is introduced into vessel 12. Once the clip 140 is applied, the envelope 22, including the wrap assembly 40 and/or the support 130 positioned within the interior receiving space 24, may be positioned within a chamber assembly 50, as described in more detail elsewhere herein.

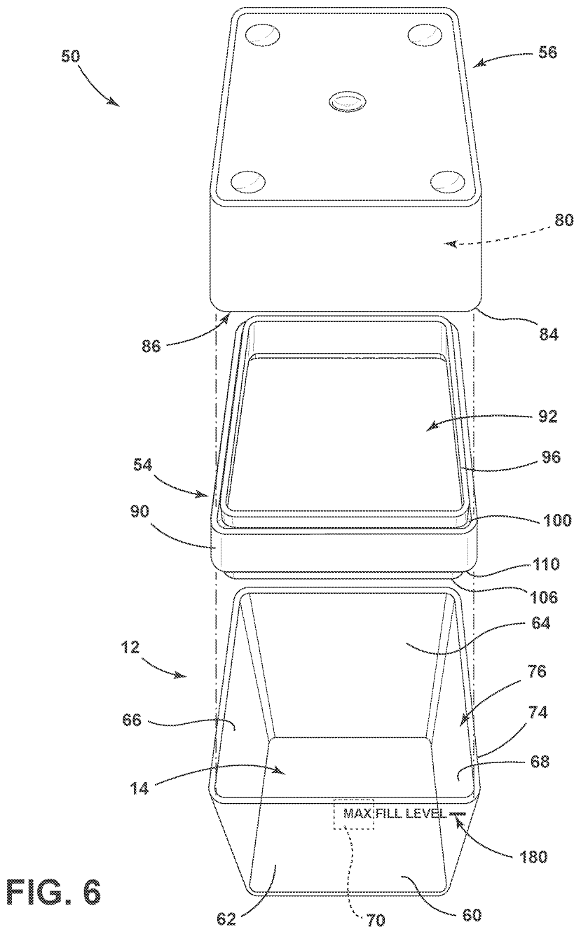

Referring now to FIG. 6, the system 10 further includes a chamber assembly 50. The chamber assembly 50 includes the vessel 12, a coupler 54, and a lid 56 oriented in a stack. Together, the vessel 12, the coupler 54, and/or the lid 56 may form a sealed assembly for germinating plants that is airtight except when providing water to the vessel 12. The vessel 12 defines a cavity 14 configured to receive at least one wrap assembly 40 and a rooting medium 26. As shown in FIG. 6, the vessel 12 is generally shaped as a rectangular prism and includes a bottom wall 60, a front wall 62, a rear wall 64, a first side wall 66, and a second side wall 68. However, it is contemplated that the vessel 12 may have any shape or size to accommodate wrap assemblies 40 without departing from the scope of the present disclosure.

The vessel 12 may further include an upper edge 74 formed by the front wall 62, the rear wall 64, the first side wall 66, and the second side wall 68. The upper edge 74 may define an open end 76 of the vessel 12 in communication with the cavity 14. The bottom wall 60 of the vessel 12 may be configured to allow insertion of water into the cavity 14. For example, as shown in FIG. 6, the bottom wall 60 may include a valve 70 configured to allowed insertion of water into the cavity 14 of the vessel 12. However, it is contemplated that water may be added into the cavity 14 through any of the walls 60, 62, 64, 66, 68 of the vessel 12, through the lid 56, or through any other portion of the chamber assembly 50 without departing from the scope of the present disclosure.

In various examples, the lid 56 may be the same shape as the vessel 12. For example, the lid 56 may define a cavity 80. The lid 56 may include a lower edge 84 configured to align with the upper edge 74 of the vessel 12. The lower edge 84 of the lid 56 may define an open end 86 of the lid 56 configured to be in communication with the cavity 80. When the lid 56 is engaged with the vessel 12, the open end 86 of the lid 56 may be aligned with and in communication with the open end 76 of the vessel 12 such that the cavity 14 of the vessel 12 is also in communication with the cavity 80 of the lid 56.

The coupler 54 is configured to be positioned between the vessel 12 and the lid 56. The coupler 54 may have the same shape as the upper edge 74 of the vessel 12 and the lower edge 84 of the lid 56. The coupler 54 may be configured to engage with the upper edge of the vessel 12 and the lower edge 84 of the lid 56 to couple the lid 56 to the vessel 12.

As shown in FIG. 6, the coupler 54 may have an outer wall 90 defining a space 92. The coupler 54 may further include a first inner edge 96 offset from the outer wall 90 into the space 92 at a first end of the coupler 54. The first inner edge 96 and the outer wall 90 form a first lip 100 of the coupler 54. The first inner edge 96 may be configured to be received by the open end 76 of the vessel 12 such that the first lip 100 of the coupler 54 is in contact with the upper edge 74 of the vessel 12. However, it is contemplated that the coupler 54 could include channels, tabs, or other features configured to engage the coupler 54 with the vessel 12 in place of or in conjunction with the first lip 100 without departing from the scope of the present disclosure.

The coupler 54 further includes a second inner edge 106 offset from the outer wall 90 into the space 92 at a second end of the coupler 54. The second inner edge 106 may be configured to be substantially parallel with the first inner edge 96 and may extend in a direction opposite the first inner edge 96. The second inner edge 106 and the outer wall 90 form a second lip 110 of the coupler 54. The second inner edge 106 may be configured to be receive by the open end 86 of the lid 56 such that the second lip 110 of the coupler 54 is in contact with the lower edge 84 of the lid 56. However, it is contemplated that the coupler 54 could include channels, tabs, or other features configured to engage the coupler 54 with the lid 56 in place of or in conjunction with the second lip 110 without departing from the scope of the present disclosure.

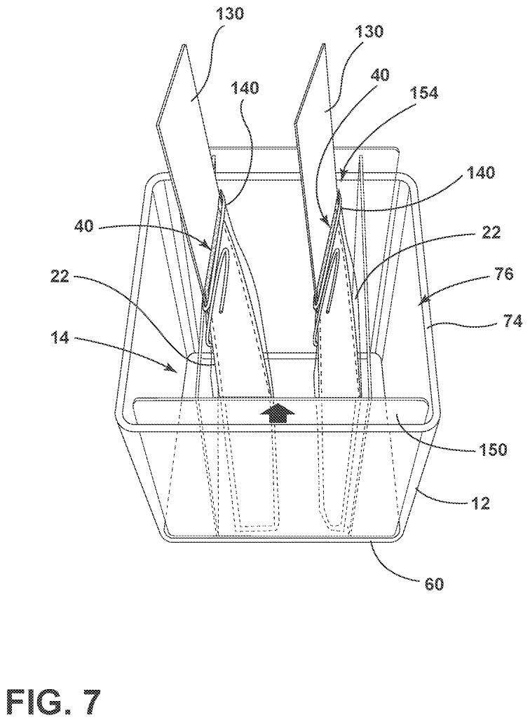

As shown in FIG. 7, the system 10 may further include a fixture 150 configured to be received by the cavity 14 of the vessel 12. The fixture 150 may define one or more center compartments 154 configured to receive one or more envelopes 22 having a wrap assembly 40 and hold the one or more envelopes 22 vertically while rooting medium 26 is added, as discussed in more detail elsewhere herein. The fixture 150 may include a plurality of walls positioned perpendicular to each other to form the one or more center compartments 154, as shown in FIG. 7. For example, the fixture 150 may have a pair of walls extending in a first direction and a second pair of walls extending between the first pair of walls at approximately 90 degree angles to form the center compartment 154. In various examples, the fixture 150 may be about 6 centimeters wide, about 6 centimeters deep, and about 9 centimeters high. However, it will be understood that the fixture 150 may be any size or shape configured to be received by the cavity 14 of the vessel 12 and retain one or more envelopes 22 in an upright position within the cavity 14. The fixture 150 may be formed of a rigid or semi-rigid material, such as, for example, plastic. However, it will also be understood that the fixture may be formed of any material configured to be received by the cavity 14 of the vessel 12 and retain one or more envelopes 22 in an upright position within the cavity 14.

The system 10 further includes a rooting medium 26 configured to be positioned within the cavity 14 of the vessel 12. In various examples, the rooting medium 26 may be a clay particle rooting material. For example, the rooting medium 26 may be formed of a clay particle substrate such as arcillite. However, it will be understood that the rooting medium 26 may be any rooting medium 26 configured to allow nutrients and water to pass through the envelope 22 to the seed 16 and germinate a plant from the seed. The rooting medium 26 may further include fertilizer such as, for example, a slow-release fertilizer mixed in with the rooting medium 26.

In some embodiments, the rooting medium 26 may include particles having an average diameter. The rooting medium 26 is selected to have an average particle diameter greater than the average particle diameter capable of passing through the material of the envelope 22 and/or the layer 20. In other words, the material of the envelope 22 and/or the layer 20 is configured to prevent particles having an average diameter that is at least as great as the average diameter of the rooting medium 26 from passing through the material of the envelope 22 and/or the layer 20. For example, where the material of the envelope 22 and/or the layer 20 is configured to prevent particles having an average diameter of about 2 millimeters from passing through, the rooting medium 26 is selected to have an average diameter of at least about 2 millimeters. In some embodiments, the rooting medium 26 may include particles having a minimum diameter greater than the minimum particle diameter capable of passing through the material of the envelope 22. For example, the rooting medium 26 may include particles having a minimum diameter greater than about 1 millimeter, about 2 millimeters, about 3 millimeters, about 4 millimeters, about 5 millimeters, or any value or range of values therebetween. The rooting medium 26 may further be selected to hold the envelope(s) 22 in place within the container when the fixture 150 is removed.

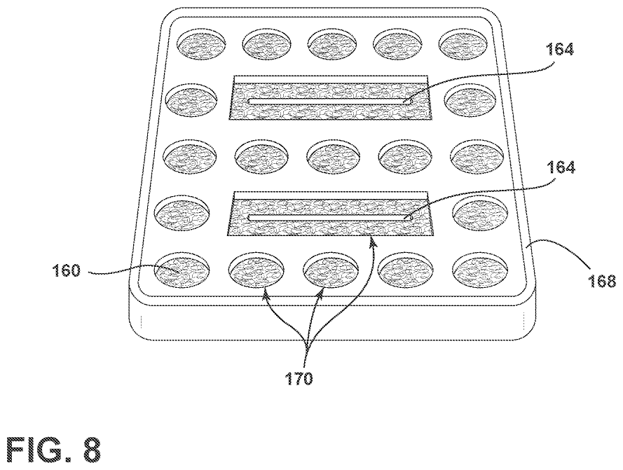

Referring now to FIG. 8, the system 10 may further include a foam insert 160 and cover 168. The foam insert 160 may be configured to fit within the open end 76 of the vessel 12. For example, where the vessel 12 is a rectangular prism having a square shaped open end 76, the foam insert 160 may be a square piece of foam. The foam insert 160 may define one or more apertures 164 configured to at least partially receive an envelope 22, wrap assembly 40, and/or support 130 (see FIGS. 11A and 11B). For example, where the vessel 12 is sized to house two envelopes 22, corresponding wrap assemblies 40 and/or supports 130, the foam insert 160 may define two apertures 164 each configured to receive a corresponding envelope 22 and wrap assembly 40.

The cover 168 may be positioned over the foam insert 160, as shown in FIG. 8. The cover 168 defines a plurality of openings 170. The plurality of openings 170 are configured to allow emergence of a plant from the seed 16 positioned within the respective envelope 22 and to provide for aeration. At least one of the plurality of openings 170 is configured to be aligned with the one or more apertures 164 of the foam insert 160. The at least one of the plurality of openings 170 aligned with the one or more apertures 164 of the foam insert 160 may be configured to at least partially receive the respective envelope 22, wrap assembly 40, and/or support 130.

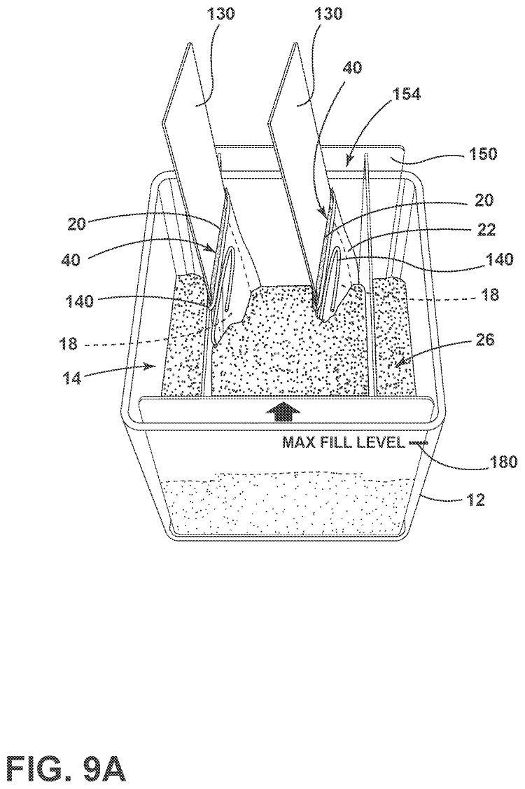

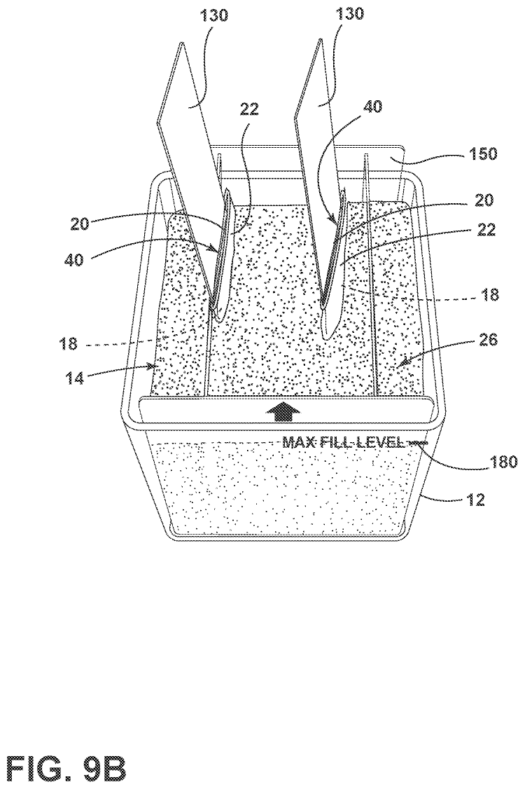

Referring now to FIGS. 9A and 9B, in application, one or more envelopes 22 may be selected and a corresponding wrap assembly 40 placed within each envelope 22 as previously described. It will be understood that the number of envelopes may be determined by the size and shape of the vessel 12 and is not limited to the configuration disclosed herein. In various examples, a corresponding support 130 may be placed within each envelope 22. The support 130 may extend outward of the envelope 22 through the opening 136. In various examples, a clip 140 or other mechanism for selectively pinching or closing the opening 136 may be removably coupled with the envelope 22 proximate the opening 136 to close the opening 136.

The fixture 150 is configured to be placed within the vessel 12. The one or more envelopes 22, corresponding wrap assemblies 40, and/or corresponding supports 130 are positioned within one of the center compartments 154 of the fixture 150. The one or more envelopes 22 are positioned such that the opening 136 of each envelope 22 is proximate the open end 76 of the vessel 12.

The rooting medium 26 may then be added to the vessel 12. In other words, the rooting medium 26 may be poured into the cavity 14 of the vessel 12. The clips 140 are configured to prevent ingress of the rooting medium 26 into the envelope(s) 22 via the respective openings 136. The rooting medium 26 is added to the vessel up to a predetermined fill line 180 of the vessel 12, as shown in FIG. 9B. In various examples, the rooting medium 26 may be added to the vessel 12 using a funnel or other guide.

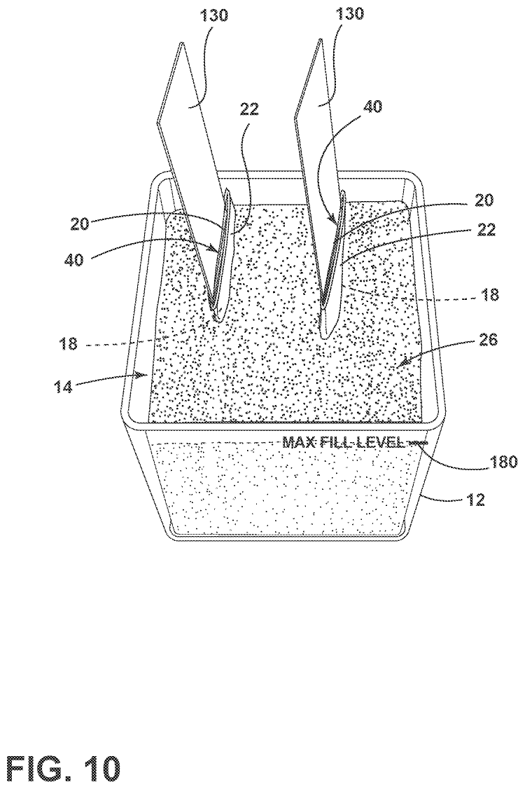

When the rooting medium 26 has reached the fill line 180 of the vessel 12, the fixture 150 is removed from the vessel 12, as shown in FIG. 10. As shown in FIGS. 11A and 11B, the foam insert 160 and cover 168 may be placed on top of the rooting medium 26 proximate the open end 76 of the vessel 12. The foam insert 160 and cover 168 are positioned to allow the envelope(s) 22, corresponding wrap assemblies 40, and/or corresponding supports 130 to extend through the respective aperture 164 of the foam insert 160 and corresponding opening 170 of the cover 168.

The support 130 may be removed from the respective envelope 22, as shown in FIG. 11B. The support 130 may be removed prior to the initiation of the imbibement of the seed(s) 16 and the initiation of plant growth/germination. For example, the support 130 may be removed prior to addition of the lid 56 to prevent the support 130 from affecting germination of the seed(s) 16.

As shown in FIG. 12, the coupler 54 may be also coupled with the open end 76 of the vessel 12. The lid 56 may also be coupled with the coupler 54 to form a complete chamber assembly 50. It is contemplated that the lid 56 may be configured to be coupled with the vessel 12 without a coupler 54 (e.g., the lid 56 may be configured to be directly coupled with the vessel 12) without departing from the scope of the present disclosure.

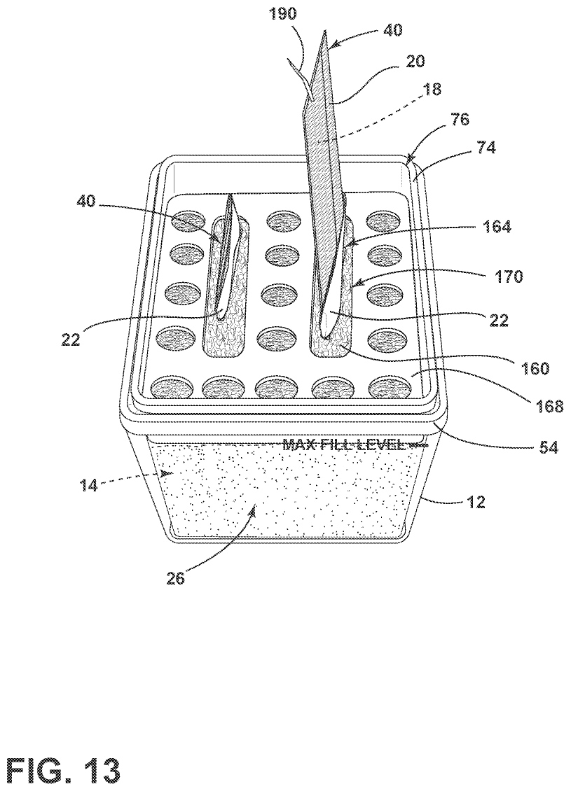

Referring now to FIG. 13, when a plant 190 has germinated, the lid 56 may be removed from the coupler 54 and/or vessel 12 and the plant 190 may be allowed to grow as desired or required by the user. The envelope 22 may be extracted from the vessel 14 through the aperture 164 of the foam insert 160. During removal of the plant 190 and the germination paper 18 and, where applicable, the layer 20, the envelope 22 is retained within the vessel 12. The retention of the envelope 22 within the rooting medium 26 within the vessel 12 is configured to ensure that the rooting medium 26 is also retained within the vessel 12 because the rooting medium 26 does not contact the germination paper 18 and/or the layer 20. Because the rooting medium 26 is prevented from contacting the germination paper 18 and/or the layer 20, the roots of the plant 190 are not in contact with the rooting medium 26 and the rooting medium 26 does not adhere to the roots of the plant 190. This is configured to prevent particles of the rooting medium 26 from being extracted which, in some instances, such as in space experiments, may create foreign object debris (FOD).

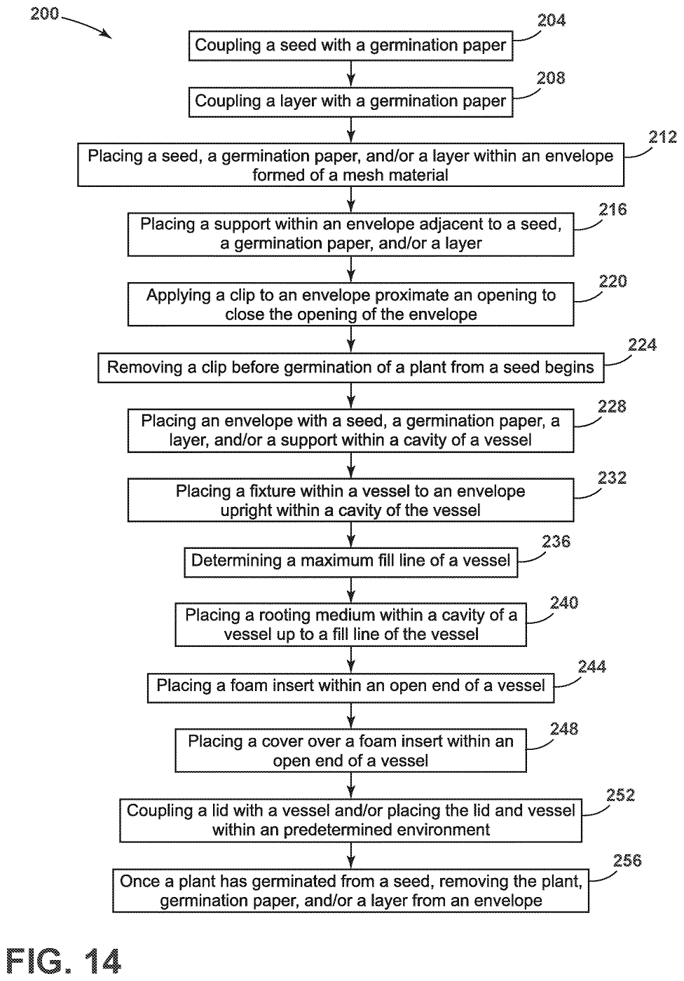

Referring now to FIG. 14, a non-limiting flow chart for an exemplary method 200 for germinating a plant in a soil medium is shown. The method 200 includes a first step 204 of coupling a seed 16 with germination paper 18. The germination paper 18 may then be folded to form a seed wrap.

At step 208, in various examples, the germination paper 18 may be coupled with a layer 20 formed of a mesh material. The layer 20 may be configured to extend at least partially around the germination paper 18. The layer 20 may be coupled with the germination paper 18 using a staple or any other mechanism for securing the layer 20. However, it is contemplated that the germination paper 18 may be used without being coupled with a layer 20 without departing from the scope of the present disclosure.

Another step 212 of the method 200 may include placing the seed 16, the germination paper 18 and/or the layer 20 within an envelope 22 formed of a mesh material. A support 130 may also be placed within the envelope 22 adjacent to the seed 16, the germination paper 18, and/or the layer 20 (step 216). A clip 140 may be applied to the envelope 22 proximate an opening 136 of the envelope 22 to close the opening 136 of the envelope 22 and prevent ingress of rooting medium 26 into the envelope 22 (step 220). The method 200 may include a step 224 of removing the clip 140 before plant germination begins.

The method 200 may further include a step 228 of placing the envelope 22 with the seed 16, the germination paper 18, the layer 20, and/or the support 130 within a cavity 14 of a vessel 12. A fixture 150 may have been placed within the vessel 12 to hold the envelope 22 upright within the cavity 14 (step 232).

A fill line 180 of the vessel 12 may be determined prior to or after insertion of the fixture 150 and the envelope 22 (step 236). The method 200 may further includes a step 240 of placing a rooting medium 26 within the cavity 14 of the vessel 12 up to the fill line 180 of the vessel 12. A foam insert 160 may then be placed within an open end 76 of the vessel 12 (step 244). The foam insert 160 defines at least one aperture 164 configured to at least partially receive at least one of the envelope 22 and the support 130. In various examples, another step 248 may include placing a cover 168 over the foam insert 160.

The method 200 may also include a step 252 of coupling a lid 56 with the vessel 12. Coupling the lid 56 with the vessel 12 may further include using a coupler 54 to couple the lid with the vessel 12 to form a chamber assembly 50. Water may be injected into the cavity 14 of the vessel 12 using a syringe or other injector. The water may be injected through one or more of walls 60, 62, 64, 66, 68 of the vessel 12. However, it is contemplated that water and nutrients may be added to the chamber assembly 50 through the lid 56 or any other portion of the vessel 12. The chamber assembly 50 may then be placed in a predetermined appropriate environment for a predetermined amount of time. In some instances, the predetermined amount of time may be until a plant 190 germinates from the seed 16. In other instances, the predetermined amount of time may be any amount of time selected by a user of the system 10.

Once a plant 190 has germinated from the seed 16 (see FIG. 13), another step 256 of the method 200 includes removing the plant 190, the germination paper 18, and, where a layer 20 was coupled with the germination paper 18, the corresponding layer 20 from the envelope 22. This removal may involve extracting the germination paper 18 and, where applicable, the corresponding layer 20, from the envelope through the corresponding aperture 164 of the foam insert 160. During removal of the plant 190 and the germination paper 18 and, where applicable, the layer 20, the envelope 22 is retained within the vessel 12. The retention of the envelope 22 within the rooting medium 26 within the vessel 12 is configured to ensure that the rooting medium 26 is also retained within the vessel 12 because the rooting medium 26 does not contact that germination paper 18 and/or the layer 20, which may prevent or reduce FOD creation upon extraction of the plant 190 and wrap assembly 40.

It will be understood by one having ordinary skill in the art that construction of the described concepts, and other components, is not limited to any specific material. Other exemplary embodiments of the concepts disclosed herein may be formed from a wide variety of materials unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise.

What is claimed is:

1. A method for germinating a plant in a soil medium comprising:
coupling a seed with the germination paper;
coupling germination paper with a layer formed of a mesh material such that the layer extends at least partially around the germination paper;
placing the seed, the germination paper, and the layer within an envelope formed of the mesh material;
placing a support within the envelope adjacent to the seed, the germination paper, and the layer;
placing the envelope with the seed, the germination paper, the layer, and the support within a vessel;
placing a rooting medium within the vessel, wherein the mesh material is configured to prevent particles having a minimum diameter that is at least as great as a minimum diameter of the rooting medium from passing through the mesh material;
placing a foam insert and a cover within the vessel, wherein the foam insert defines at least one aperture configured to at least partially receive at least one of the envelopes and the support; and
removing, once a plant has germinated from the seed, the plant, the germination paper, and the layer from the envelope.

2. The method of claim 1, wherein the rooting medium has a minimum particle diameter of about 1 mm.

3. The method of claim 1, wherein the rooting medium is retained within the vessel when the plant, the germination paper, and the layer are removed from the envelope.

4. The method of claim 1, wherein the envelope is retained within the vessel when the plant, the germination paper, and the layer are removed from the envelope.

5. The method of claim 1, further comprising:
removing the support from the envelope while leaving the seed and the germination paper in the envelope.

6. The method of claim 1, further comprising:
removing the support with the plant and the germination paper from the envelope once the plant has germinated.

7. The method of claim 1, further comprising:
coupling a lid with the vessel.

8. The method of claim 1, wherein placing the seed, the germination paper, and the layer within the envelope further includes closing an opening of the envelope to prevent ingress of rooting material into the envelope.

9. A method for germinating a plant in a soil medium comprising:
coupling a seed with germination paper;
placing the seed and the germination paper within an envelope formed of a mesh material;
placing the envelope, the seed, and the germination paper within a vessel;
placing a rooting medium within the vessel, wherein the mesh material is configured to prevent particles having a minimum diameter that is at least as great as a minimum diameter of the rooting medium from passing through the mesh material; and
removing, once a plant has germinated from the seed, the plant and the germination paper from the envelope.

10. The method of claim 9, wherein the rooting medium has an average diameter of about 2 mm.

11. The method of claim 9, further comprising:
placing a support within the envelope adjacent the seed and the germination paper.

12. The method of claim 11, further comprising:
removing the support from the envelope while leaving the seed and the germination paper in the envelope.

13. The method of claim 11, further comprising:
removing the support with the plant and the germination paper from the envelope once the plant has germinated.

14. The method of claim 9, further comprising:
positioning a layer comprising the mesh material about a portion of the germination paper prior to insertion of the germination paper within the envelope.

15. The method of claim 9, wherein the rooting medium is retained within the vessel when the plant and the germination paper are removed from the envelope.

16. The method of claim 9, wherein the envelope is retained within the vessel when the plant and the germination paper are removed from the envelope.

17. The method of claim 9, wherein placing a rooting medium within the vessel further includes:
determining a fill level of the vessel;
placing the rooting medium within the vessel until the rooting medium reaches the fill level of the vessel;
placing a foam insert within the vessel adjacent the rooting medium; and
placing a cover over the foam insert.

18. A system for germinating a plant in a soil medium comprising:
a vessel defining a cavity;
a germination paper;
a seed coupled with the germination paper;
a layer positioned at least partially around the germination paper;
an envelope positioned within the cavity and defining a receiving space, the envelope comprising a mesh material, wherein the germination paper and the layer are configured to be at least partially received by the receiving space of the envelope; and
a rooting medium positioned within the cavity of the vessel, wherein the mesh material is configured to prevent particles having a minimum diameter that is at least as great as a minimum diameter of the rooting medium from passing through the mesh material.

19. The system of claim 18, further comprising:
a foam insert positioned within the cavity of the vessel, the foam insert defining at least one opening configured to at least partially receive the envelope; and
a cover coupled with the vessel and positioned adjacent the foam insert.

20. The system of claim 18, wherein the rooting medium has a minimum diameter of about 1 mm.
